(19) United States
(12) Patent Application Publication
(10) Pub. No.: US 2006/0178445 A1
(43) Pub. Date: Aug. 10, 2006

(54) Composition for controlled sustained release of a gas

(76) Inventors: Patrick F. Mcintyre, West Chester, PA (US); William Harvey Morrison JR., Wilmington, DE (US); John Gavenonis, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/299,126

(22) Filed: Dec. 9, 2005

Related U.S. Application Data
(60) Provisional application No. 60/636,609, filed on Dec. 16, 2004.

(51) Int. Cl. C09D 5/16

(52) U.S. Cl. 523/122

(57) ABSTRACT

The invention relates to an improved composition for generating at least one gas comprising an energy-activated catalyst capable of being activated by electromagnetic energy, heat and/or moisture and anions capable of being oxidized or reacted to generate at least one gas, the composition, when exposed to electromagnetic energy, heat and/or moisture being capable of generating and releasing the gas after activation of the catalyst and oxidation or reaction of the anions. The process comprises: (a) metering a liquid composition comprising a source of the anions, specifically sodium chlorite, into a flow restrictor; (b) injecting a gas stream through the flow restrictor, concurrently with step (a) to create a zone of turbulence at the outlet of the flow restrictor, thereby atomizing the liquid composition; (c) heating the gas stream prior to injecting the gas stream through the flow restrictor; and (d) adding the energy-activated catalyst, specifically titanium dioxide, to the zone of turbulence concurrently with steps (a) and (b) to contact the energy-activated catalyst with the atomized liquid composition wherein the contacting at the zone of turbulence treats the energy-activated catalyst with the source of the anions. The titanium dioxide can be pigmentary or nano-sized. The composition can be useful in polymeric composition, specifically for making a body covering article.

### CROSS REFERENCE TO RELATED APPLICATIONS

This application claims the benefit of U.S. Provisional Application 60/636,609 filed on Dec. 16, 2004, which is incorporated herein by reference in its entirety.

### BACKGROUND OF THE INVENTION

1. Field of the Invention

This invention relates to a composition for sustained controlled release of a gas, more particularly an improved process for treating titanium dioxide pigment for controlled sustained release of a gas. Yet more particularly, this invention relates to a process for treating a titanium dioxide pigment particle with a source of anions capable of being oxidized or reacted to generate a gas.

2. Description of the Related Art

Energy-activated compositions for controlled sustained release of a gas are described in WO00/69775. The composition is said to be activated by electromagnetic energy to provide controlled sustained generation and release of at least one gas. The composition includes an energy-activated catalyst and anions capable of being oxidized by the activated catalyst surface or subsequent reaction product to generate a gas, for retarding, controlling, killing or preventing microbiological contamination (e.g., bacteria, fungi, viruses, mold spores, algae, and protozoa), deodorizing, enhancing freshness, and/or retarding, preventing, inhibiting, or controlling chemotaxis by release of a gas or a combination of gases, such as chlorine dioxide. The composition is described in one embodiment as a plurality of particles including a core having a layer on an outer surface of the core or having particles on an outer surface of the core. A salt described as suitable for use as the anion source is an alkali metal chlorite. Anatase, rutile or amorphous titanium dioxide is described as a suitable energy-activated catalyst.

A fluidization process is mentioned is WO00/69775 as a method for preparing the compositions. However, attempting to use a fluid bed to surface treat titanium dioxide would be expected to have problems with severe aggregation of the pigment, non-uniform surface treatment, and very poor fluidization of the titanium dioxide because of its cohesiveness manifested in channeling, nonuniform gas flow, etc. causing difficulty in operating the bed or maintaining the operation for any significant length of time.

Another described method in WO 00/69775 for making the composition is by spray drying a suspension of the particles. Spray drying processes have a certain appeal for treating temperature-sensitive materials such as sodium chlorite because of the low temperatures and mild conditions.

There exists a need for increasing the amount of gas generated by compositions which include an energy-activated catalyst and anions capable of being oxidized by the activated catalyst surface or subsequent reaction product. There is also a need for making the composition in an efficient and economical way.

Mixing one material with a particulate material in a zone of turbulence has been described in U.S. Pat. No. 4,430,001 to Schurr. Improving the flowability of rutile titanium dioxide by coating with naphthenic acid in a zone of turbulence is described in U.S. Pat. No. 4,303,702. The foregoing process is known for being able to make products which have significantly better dispersion properties than spray-dried materials. However, in contrast with spray drying the temperatures are high and the turbulent conditions are harsh. A manufacturing process for making compositions for controlled sustained release of a gas that can be used with temperature sensitive materials such as sodium chlorite would be desirable.

### SUMMARY OF THE INVENTION

It has been found that mixing an energy-activated catalyst in a zone of turbulence with a source of anions capable of being oxidized by the activated catalyst or reacted with species generated during activation of the catalyst to generate a gas produces a composition which can generate higher quantities of gas than compositions formed by spray drying. The high temperatures and harsh conditions of this process do not appear to have a negative impact on a temperature sensitive source of anions such as sodium chlorite probably because of the short residence time and rapid flow rates.

The invention is directed to an improved composition for generating at least one gas comprising a core containing an energy-activated catalyst capable of being activated by electromagnetic energy, heat and/or moisture and anions capable of being oxidized or reacted to generate at least one gas, the composition, when exposed to electromagnetic energy, heat and/or moisture being capable of generating and releasing the gas after activation of the catalyst and oxidation or reaction of the anions, wherein the improvement comprises the process of:

(a) metering a liquid composition comprising a source of the anions into a flow restrictor;

(b) injecting a gas stream through the flow restrictor, concurrently with step (a) to create a zone of turbulence at the outlet of the flow restrictor, thereby atomizing the liquid composition;

(c) heating the gas stream prior to injecting the gas stream through the flow restrictor; and

(d) adding the energy-activated catalyst to the zone of turbulence concurrently with steps (a) and (b) to contact the energy-activated catalyst with the atomized liquid composition wherein the contacting at the zone of turbulence treats at least a portion of the energy-activated catalyst with the source of the anions. The invention is also directed to an improved process for making the composition.

In another embodiment the invention is directed to using the improved composition in a polymeric article that generates and releases gas upon activation by electromagnetic energy and/or moisture. The polymeric article can be a film or more specifically a body covering article.

When chlorite is employed and heat is used to activate the catalyst the temperature is typically above about 50° C. At such temperatures chlorite liberation is seen. Other liberated materials are also seen such as ClO and free chlorine.

### BRIEF DESCRIPTION OF THE DRAWINGS

FIG. 1 is a schematic diagram of a portion of the apparatus in accordance with the present invention.

FIG. 2 is a cut-away, expanded, cross-sectional view of a portion of the apparatus shown in FIG. 1.

FIG. 3 is a scanning electron micrograph of a sample of the composition.

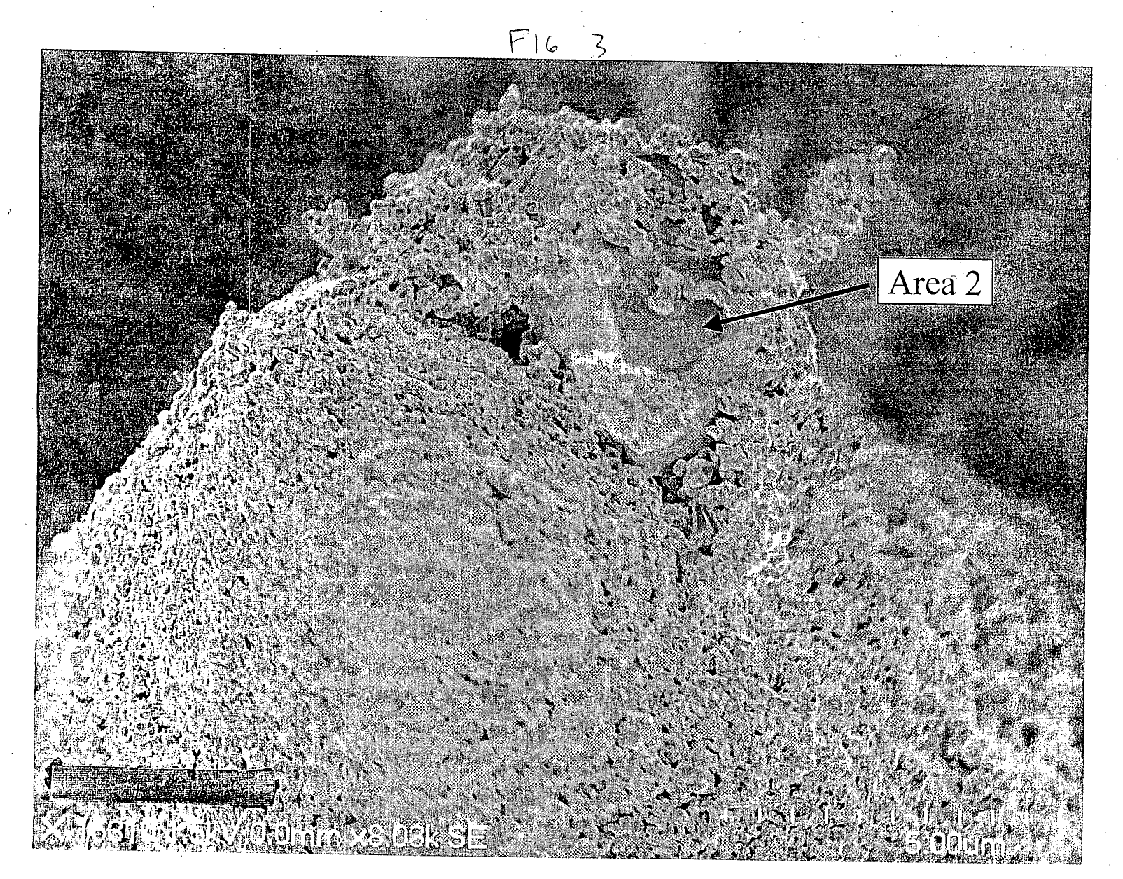

FIG. 4 shows peaks associated with the composition of FIG. 3.

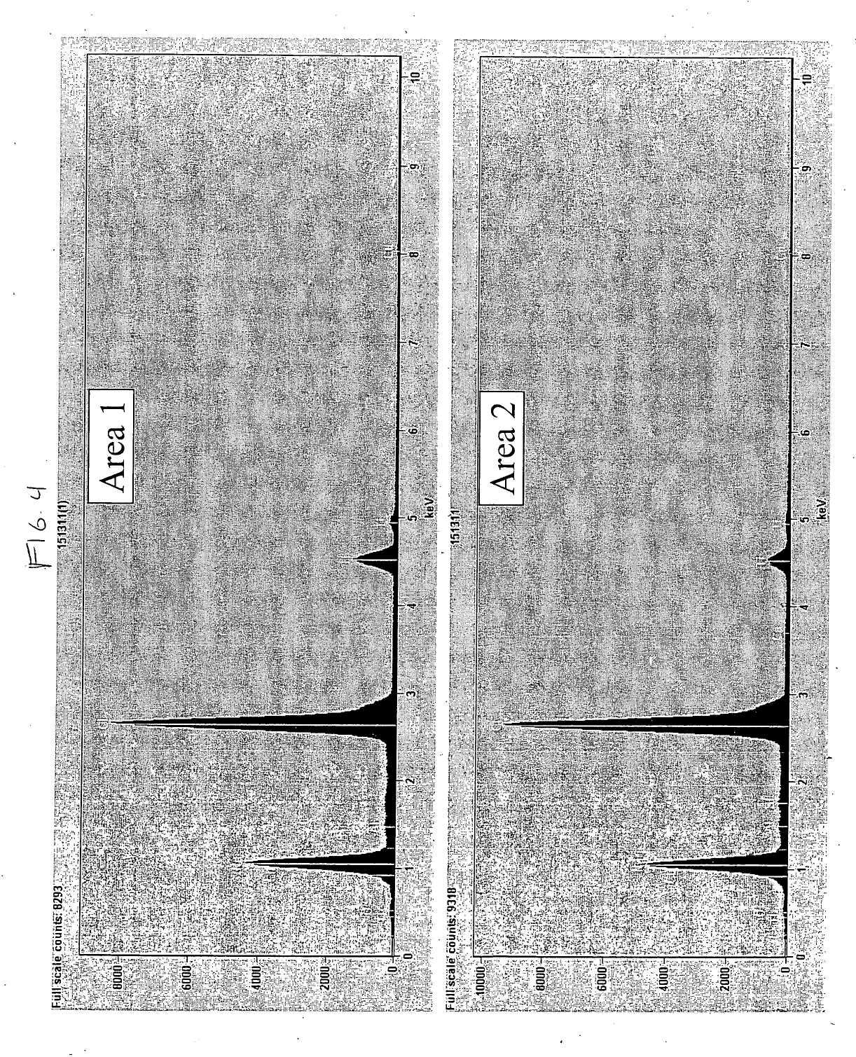

### DETAILED DESCRIPTION OF THE PREFERRED EMBODIMENTS

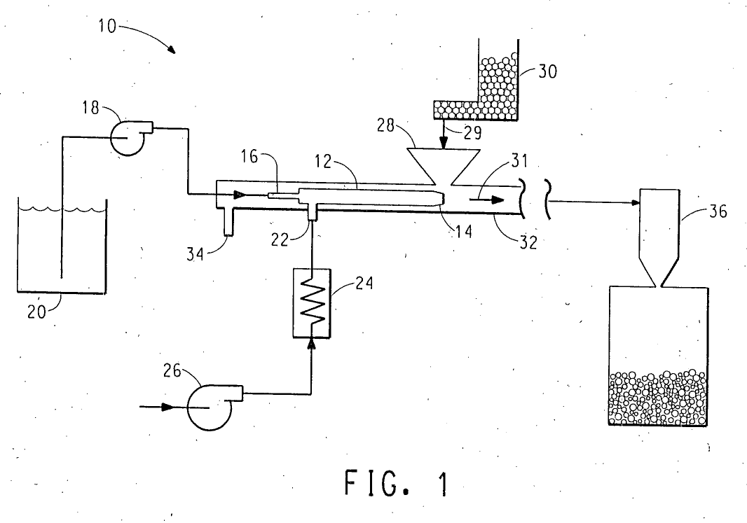

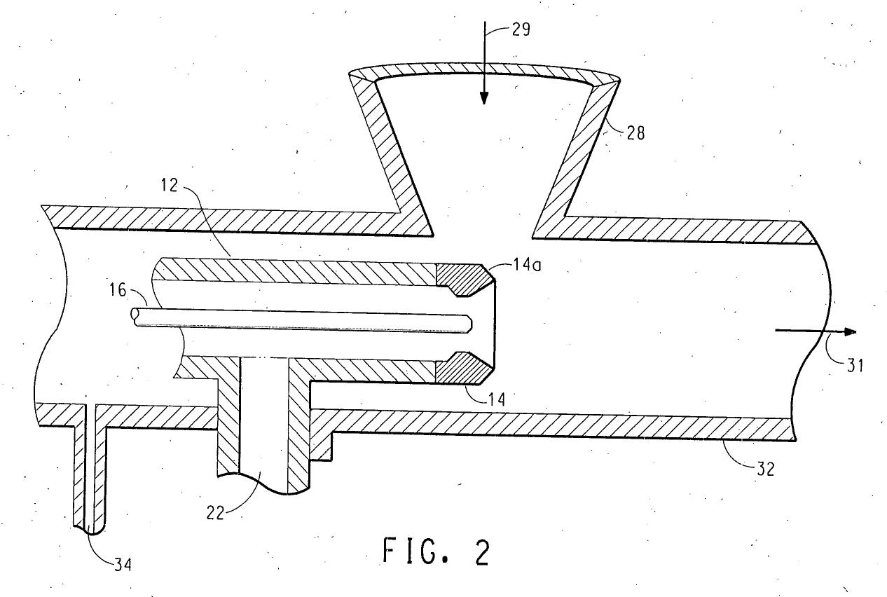

In accordance with the present invention, there is provided a process for treating an energy-activated catalyst with anions capable of being oxidized or reacted to generate at least one gas. It should be noted that the process of the present invention may be practiced using the apparatus illustrated in FIGS. 1 and 2, although it should be understood that the process of the present invention is not limited to the illustrated apparatus. Moreover, it should be noted that while one pass, or cycle, of the process of the present invention can provide effective treatment of the energy-activated catalyst, more than one pass may be used. The treatment has not been seen to coat or encapsulate the energy-activated catalyst but full or partial coating or encapsulation is not excluded from the scope of the invention.

Wherever possible, the same reference numbers will be used throughout the drawings to refer to the same or like parts.

The process comprises the steps of metering a liquid composition of a source of the anions into a flow restrictor, such as flow restrictor 14 as shown in FIGS. 1 and 2. The liquid composition may be a solution, slurry or melt.

The process of the present invention further comprises injecting a gas stream, for instance from a gas inlet line such as that shown at 22 in FIGS. 1 and 2, through the flow restrictor concurrently with metering the liquid composition into the flow restrictor, to create a zone of turbulence at the outlet of the flow restrictor. The shear in the zone of turbulence atomizes the liquid composition and can deagglomerate the catalyst.

The gas stream is heated prior to injecting it through the flow restrictor. The gas stream may be heated by a heater, such as heater 24 as shown in FIG. 1. When the liquid composition is a solution or a slurry, the gas stream is heated to a temperature sufficient to vaporize the liquid of the solution or slurry and preferably to leave solid of the solution or slurry remaining. When the treating composition is a melt, the gas stream should be heated to a temperature at or above the melt temperature to keep the composition in a fluid state, and in particular, the melt, in liquid (i.e., melt) form. When using a melt, it is also helpful if auxiliary heat is provided to the first inlet line which supplies the melt prior to injection, to prevent pluggage of the line.

The process of the present invention also comprises the step of adding an energy-activated catalyst to the zone of turbulence concurrently with the metering of the liquid composition and the injection of the gas stream. This contacts, or additionally mixes, the energy-activated catalyst with the atomized liquid composition in the zone of turbulence. This contacting in the zone of turbulence provides a composition in which the energy-activated catalyst is treated with the anion. The energy-activated catalyst is preferably metered in order to control the ratio of the solid and the liquid added at the zone of turbulence. This establishes the level of treatment. When a solution or slurry is used, the heat from the heated gas stream serves to vaporize the liquid of the solution or slurry, leaving the solids in the solution or slurry remaining to treat the energy-activated catalyst. The mixing in the zone of turbulence then treats the energy-activated catalyst with the remaining solids from the solution or slurry. When a melt is used, the mixing at the zone of turbulence treats the energy-activated catalyst with the constituents of the melt.

As noted above, the zone of turbulence is formed by the action of injecting the gas at high pressure through the flow restrictor. It is preferable that the gas stream is accelerated to at least about one-half the velocity of sound prior to injection to ensure that a zone of turbulence of sufficient intensity will be formed at the outlet of the flow restrictor.

The residence time of the particles in the zone of turbulence is determined by the geometry of the first chamber and the amount of gas injected from the gas inlet line. The average residence time of the energy-activated catalyst within the zone of turbulence is preferably less than 250 milli-seconds. More preferably, the average residence time of the energy-activated catalyst within the zone of turbulence is in the range of 25 to 250 milli-seconds. Residence times can be varied by adjusting nozzle pressure which influences flow rate. High nozzle pressure increases flow rate and low nozzle pressure decreases flow rate. Short residence times can be achieved because of the action of the zone of turbulence. The short residence times make the process of the present invention advantageous compared to conventional processes such as spray drying because the time, and hence, the costs of treating the energy-activated catalyst, are reduced. Moreover, the process of the present invention is advantageous because it can provide a product having a high weight percent of the anions. Typically the amount of anions present depends upon the amount of the source of the anion that is used and the concentration and the flow rate at which it is metered. The concentration and flow rate of the source of anion into the apparatus can be matched to the flow rate of the catalyst to obtain the desired treatment level. When about 5% source of anions is used the amount of anions detected in a sample of the treated the energy-activated catalyst, as determined by the ion chromatography procedure described hereinbelow, can be at least about 2 wt. % anions based on the entire weight of the catalyst and salt, typically at least about 2.5 wt. %, more typically about 3 wt. % and even up to and including about 4 wt. % and even higher.

Typically, the energy-activated catalyst is fed from a hopper, such as hopper 28 as shown in FIGS. 1 and 2, which is open to the atmosphere. When the liquid composition is a melt, it is preferred that the energy-activated catalysts be at ambient temperature because this will facilitate solidification of the melt after the melt (which is initially at a higher temperature) treats the energy-activated catalyst in the zone of turbulence.

The process of the present invention may further comprise the step of adding another gas stream upstream of the zone of turbulence for cooling and conveying the treated energy-activated catalyst. This other gas stream is added through a chamber, such as second chamber 32 as shown in FIGS. 1 and 2. The pressure of the second gas stream must be sufficient to assist in conveying the treated energy-activated catalysts from the zone of turbulence to the collection container, but should be at a pressure lower than the pressure of the first gas stream in order to achieve effective treatment. Nozzle pressure can range from about 50 psi to about 100 psi, typically from about 60 psi to about 85 psi. When a solution or slurry is used, the solid of the solution or slurry cools and solidifies in the second chamber between the zone of turbulence and a collection container, such as collection zone 36. When a melt is used, the melt cools and solidifies in the second chamber between the zone of turbulence and the collection container. When a second chamber is not included, the solid or the melt cools and solidifies in the atmosphere between the zone of turbulence and the collection container, and the product falls into the container.

A suitable temperature is the temperature of the motive gas (e.g. nitrogen) that is able to convey the catalyst through the outlet of the second chamber 32.

The present invention provides for an apparatus for treating an energy-activated catalyst with salt. The product can comprise crystals of the salt surrounded by crystals of the catalyst. Electron microscopy has shown relatively large particles of the salt (multi-crystalline or single crystals). The salt crystals seen are many times larger than the catalyst crystals. The salt crystals can be single crystals or agglomerates.

An apparatus that can be used in the process of the present invention is shown generally at 10 in FIG. 1. The apparatus comprises a first chamber, shown at 12 in FIGS. 1 and 2. A flow restrictor 14 is disposed at one end of the first chamber. The flow restrictor is typically disposed at the downstream end of the first chamber, as shown in FIGS. 1 and 2. Flow restrictor 14 has an outlet end 14a, as shown in the detailed view of FIG. 2. Although the flow restrictor is shown as a different element from the first chamber, it may be formed integrally therewith, if desired. The flow restrictor may have various configurations, as long as it serves to restrict flow and thereby increase the pressure and thus the flow rate of the fluid passing through it. Typically, the flow restrictor is a nozzle.

A first, or liquid, inlet line 16 as shown in FIGS. 1 and 2 is disposed in fluid communication with the first chamber for metering a liquid composition into the chamber. Liquid inlet line 16 meters the liquid composition into first chamber 12 in the outlet of flow restrictor 14, and preferably in the center of the flow restrictor when viewed along the axial length thereof. The liquid composition is metered through liquid inlet line 16 by a metering pump 18 from a storage container 20 containing the liquid composition as shown in FIG. 1. The liquid composition may be a solution, containing a dissolved solid which is used as the treating material or a slurry, where a solid which is used as the treating material is undissolved in a liquid. Alternatively, the liquid composition may be a melt, which is used as the treating material. By melt is meant any substance at a temperature at or above its melting point, but below its boiling point. In any of these cases, the liquid composition may include components other than the treating material. It should be noted that when the liquid composition is a melt, storage container 20 must be heated first to a temperature above the melt temperature of the liquid composition in order to maintain the liquid composition in melt form prior to injection.

The apparatus for treating an energy-activated catalyst further includes a second, or gas, inlet line 22 disposed in fluid communication with the first chamber as shown in FIGS. 1 and 2. Generally, the gas inlet line should be disposed in fluid communication with the first chamber upstream of the flow restrictor. Gas inlet line 22 injects a first gas stream through the flow restrictor to create a zone of turbulence at the outlet of the flow restrictor. The turbulence subjects the liquid composition to shear forces that atomize the liquid composition.

The first gas stream should have a stagnation pressure sufficient to accelerate the gas to at least one-half the velocity of sound, or greater, prior to entering the flow restrictor to ensure that a zone of turbulence of sufficient intensity will be formed at the outlet of the flow restrictor. The velocity of sound for a particular gas stream, e.g., air or nitrogen, will be dependent on the temperature of the gas stream. This is expressed by the equation for the speed of sound, c:
c=\sqrt{kgRT} (1)
where:
k=ratio of specific heats for the gas
g=acceleration of gravity
R=universal gas constant
T=absolute temperature of the gas
   Thus, the acceleration of the first gas stream is dependent on the temperature of the gas stream.

As noted above, it is the pressurized gas that causes the atomization of the liquid composition. The pressure of the liquid composition in the liquid inlet line just needs to be enough to overcome the system pressure of the gas stream. It is preferable that the liquid inlet line has an extended axial length before the zone of turbulence. If the liquid inlet line is too short, the flow restrictor can become plugged.

The apparatus of the present invention also comprises means disposed in the second inlet line and upstream of the flow restrictor for heating the first gas stream prior to injection through the flow restrictor. Preferably, the heating means comprises a heater 24 as shown in FIG. 1. Alternatively, the heating means may comprise a heat exchanger, a resistance heater, an electric heater, or any type of heating device. Heater 24 is disposed in second inlet line 22. A pump 26 as shown in FIG. 1 conveys the first gas stream through heater 24 and into first chamber 12. When a melt is used as the treating material, the gas stream should be heated to a temperature at or above the melt temperature of the melt, to keep the melt in liquid (i.e., melt) form. When using a melt, it is also helpful if auxiliary heat is provided to the first inlet line which supplies the melt prior to injection, to prevent pluggage of the line.

The apparatus of the present invention further includes a hopper 28 as shown in FIGS. 1 and 2. Hopper 28 introduces an energy-activated catalyst to the zone of turbulence. It is preferable that the outlet end of the flow restrictor is positioned in the first chamber beneath the hopper at the center line of the hopper. This serves to ensure that the energy-activated catalyst is introduced directly into the zone of turbulence. This can be important because, as noted above, the turbulence subjects the liquid composition to shear forces that atomize the liquid composition. It also increases operability by providing a configuration for feeding the energy-activated catalysts most easily. In addition, the shear forces disperse and mix the atomized liquid composition with the energy-activated catalyst, which allows the catalyst particles to be treated. Hopper 28 may be fed directly from a storage container 30 as shown by arrow 29 in FIG. 1. The hopper of the present invention may include a metering device for accurately metering the energy-activated catalyst at a particular ratio to the liquid feed from liquid inlet line 16 into the zone of turbulence. This metering establishes the level of treatment of the energy-activated catalyst. Typically, the hopper of the present invention is open to the atmosphere. When a melt is used, it is preferred that the energy-activated catalyst is at ambient temperature because this facilitates solidification of the melt after the melt, which is initially at a higher temperature, treats the energy-activated catalyst in the zone of turbulence.

The apparatus of the present invention may further include a second chamber 32 surrounding the first chamber as shown in FIGS. 1 and 2. In addition, the second chamber encloses the zone of turbulence. Second chamber 32 has an inlet 34 for introducing a second gas stream into the second chamber. The inlet of the second chamber is preferably positioned at or near the upstream end of second chamber 32. The outlet of second chamber 32 is connected to a collection container, such as that shown at 36 in FIG. 1. The second gas stream cools and conveys the treated energy-activated catalyst towards the collection container as illustrated by arrow 31 in FIG. 2. In particular, when a solution or slurry is used, the solid of the solution or slurry cools between the zone of turbulence and container so that by the time the particle reaches the collection container, a solid comprising the solid of the solution or slurry is formed. When a melt is used, the liquid composition cools between the zone of turbulence so that by the time the particle reaches the container, a solid comprising the melt is formed. The first gas stream, as well as the second gas stream, are vented through the top of collection container 36.

For the configuration as shown in FIGS. 1 and 2, inlet 34 may be connected to a blower, not shown, which supplies the second gas stream to the second chamber. However, the blower and second chamber 32 may be eliminated, and the first gas stream may be used to cool the particles and to convey them to container 36. In this case, the solid from the solution or slurry or the melt cools and solidifies in the atmosphere between the zone of turbulence and the collection container, and the product falls into collection container 36.

It is preferable that the axial length of the zone of turbulence is about ten times the diameter of the second chamber. This allows the pressure at the outlet of the flow restrictor to be at a minimum. Energy-activated catalysts are fed into second chamber 32 as shown in FIGS. 1 and 2 near the outlet of the flow restrictor, which is preferably positioned at the center line of the hopper. If the pressure at the outlet is too great, the energy-activated catalyst will back flow into the hopper.

The pressure of the second gas stream must be sufficient to assist in conveying the treated energy-activated catalyst from the zone of turbulence to the collection zone, but should be at lower than the pressure of the first gas stream. This is because a high relative velocity difference between the first gas stream and the second gas stream produces a sufficient degree of turbulence to treat the energy-activated catalyst.

Feed rate of the source of anion will depend upon the solution concentration. For a 25% solution, the feed rate of the source of anion is typically from about 10 to about 100 g/minute. The feed rate of the energy-activated catalyst is typically from about 50 to about 400, typically about 100 to about 400 g/minute. When the source of anion is a chlorite, typical treatment with chlorite ion is about 2 wt. % using 3.35 wt. % technical grade sodium chlorite to about 10 wt. % using 16.8 wt. % technical grade sodium chlorite based on the entire weight of the catalyst and salt.

Suitable salts for use as the anion source include an alkali metal chlorite, an alkaline-earth metal chlorite, a chlorite salt of a transition metal ion, a protonated primary, secondary or tertiary amine, or a quaternary amine, an alkali metal bisulfite, an alkaline-earth metal busulfite, a bisulfite salt of a transition metal ion, a protonated primary, secondary or tertiary amine, or a quaternary amine, an alkali metal sulfite, an alkaline-earth metal sulfite, a sulfite salt of a transition metal ion, a protonated primary, secondary or tertiary amine, or a quaternary amine, an alkali metal sulfide, an alkaline-earth metal sulfide, a sulfide-salt of a transition metal ion, a protonated primary, secondary or tertiary amine, or a quaternary amine, an alkali metal bicarbonate, an alkaline-earth metal bicarbonate, a bicarbonate salt of a transition metal ion, a protonated primary, secondary or tertiary amine, or a quaternary amine, an alkali earth metal carbonate, an alkaline-earth metal carbonate, a carbonate salt of a transition metal ion, a protonated primary, secondary or tertiary amine, or a quaternary amine, an alkali metal hydrosulfide, an alkaline-earth metal hydrosulfide, a hydrosulfide salt of a transition metal ion, a protonated primary, secondary or tertiary amine, or a quaternary amine, an alkai metal nitrite, an alkaline-earth metal nitrite, a nitrite salt of a transition metal ion, a protonated primary, secondary or tertiary amine, or a quaternary amine, an alkali metal hypochlorite, an alkaline-earth metal hypochlorite, a hypochlorite salt of a transition metal ion, a protonated primary, secondary or tertiary amine, or a quaternary amine, an alkali metal cyanide, an alkaline-earth metal cyanide, a cyanide salt of a transition metal ion, a protonated primary, secondary or tertiary amine, or a quaternary amine, an alkali metal peroxide, an alkaline-earth metal peroxide, or a peroxide salt of a transition metal ion, a protonated primary, secondary or tertiary amine, or a quaternary amine. Preferred salts include sodium, potassium ,calcium, lithium, or ammonium salts of a chlorite, bisulfite, sulfite, sulfide, hydrosulfide, bicarbonate, carbonate, hypochlorite, nitrite, cyanide or peroxide. Commercially available forms of chlorite and other salts suitable for use can contain additional salts and additives such as tin compounds to catalyze conversion to a gas.

The gas released by the composition will depend upon the anions that are oxidized or reacted. Any gas formed by the loss of an electron from an anion, by reaction of an anion with electromagnetic energy-generated protic species by reduction of a cation in an oxidation/reduction reaction, or by reaction of an anion with a chemisorbed molecular oxygen, oxide or hydroxy radical can be generated and released by the composition. The gas is preferably chlorine dioxide, nitric oxide, nitrous oxide, carbon dioxide, dichlorine monoxide, chlorine or ozone or combinations thereof.

Chlorine dioxide gas is generated and released if the energy-activated catalyst contains a source of chlorite anions. Suitable chlorite sources that can be incorporated into the composition include alkali metal chlorites such as sodium chlorite or potassium chlorite, alkaline-earth metal chlorites such as calcium chlorite, or chlorite salts of a transition metal ion a protonated primary, secondary or tertiary amine or a quaternary amine such as ammonium chlorite, trialkylammonium chlorite, and quaternary ammonium chlorite. Suitable chlorite sources, such as sodium chlorite are stable at processing temperatures in excess of about 90° C. but usually are unstable at temperatures above about 180° C. Sodium chlorite has been found to be an effective source of anions when used in the process of this invention. Although the inlet temperature can be about 300° C. the temperature through the chamber is usually much lower, typically on average about 100° C.

Sulfur dioxide is generated and released if the composition contains bisulfite or sulfite anions. Bisulfite sources that can be incorporated into the compositions include alkali metal bisulfites such as sodium bisulfite or potassium bisulfite, alkaline-earth metal bisulfites such as calcium bisulfite, or bisulfite salts of a transition metal ion, a protonated primary, secondary or tertiary amine, or a quaternary amine. Such bisulfite salts dissociate in solution to form bisulfite anions and possibly sulfite anions. Sulfur dioxide gas-releasing compositions can be used for food preservation (e.g. to inhibit biochemical decomposition such as browning of produce), disinfection, and inhibition of enzyme-catalyzed reactions. The compositions can also be used for reduction of chlorine gas concentration in catalytic cycles where aluminum or iron powder is used to selectively scrub chlorine from a mixture of chlorine and chlorine dioxide. The compositions are also useful in modified atmosphere packaging by placing the composition within a package, exposing the composition to electromagnetic energy to generate sulfur dioxide, and sealing the package to create a sulfur dioxide atmosphere within the package.

Hydrogen sulfide is generated and released from a composition containing hydrosulfide or sulfide anions.

Acceptable sources of hydrosulfide anions include alkali metal hydrosulfides such as sodium hydrosulfide or potassium hydrosulfide, alkaline-earth metal hydrosulfides such as calcium hydrosulfide, or hydrosulfide salts of a transition metal ion, a protonated primary, secondary or tertiary amine, or a quaternary amine. Acceptable sources of sulfide anions include alkali metal sulfides such as sodium sulfide or potassium sulfide, alkaline-earth metal sulfides such as calcium sulfide, or sulfide salts of a transition metal ion, a protonated primary, secondary or tertiaryramine, or a quaternary amine. Hydrogen sulfide gas-releasing compositions can be used as a reducing agent or a sulfur source in the manufacture of chemicals, and as a polymerization inhibitor.

Chlorine gas and dichlorine monoxide are generated and released from a composition containing hypochlorite anions.

Acceptable sources of hypochlorite anions include alkali metal hypochlorites such as sodium hypochlorite, alkaline-earth metal hypochlorites such as calcium hypochlorite, or hypochlorite salts of a transition metal ion, a protonated primary, secondary or tertiary amine, or a quaternary amine.

Chlorine gas-releasing compositons can be used in processing meat, fish and produce and as an insecticide. Dichlorine monoxide releasing compositions can be used as a biocide.

Hydrocyanic acid is generated and released from a composition if it contains a source of cyanide anions.

Suitable sources of cyanide anions include alkali metal cyanides such as sodium cyanide or potassium cyanide, alkaline-earth metal cyanides such as calcium cyanide, or cyanide salts of a transition metal ion, a protonated primary, secondary or tertiary amine, or a quaternary amine.

Hydrocyanic acid gas-releasing compositions can be used as a pesticide or a rodenticide.

Carbon dioxide gas is generated and released if a composition contains a source of bicarbonate or carbonate anions. Suitable bicarbonate sources that can be incorporated into the compositions include alkali metal bicarbonates such as sodium bicarbonate, potassium bicarbonate, or lithium bicarbonate, alkaline-earth metal bicarbonates, or bicarbonate salts of a transition metal ion, a protonated primary, secondary or tertiary amine, or a quaternary amine such as ammonium bicarbonate. Such bicarbonate salts may dissociate in solution to form bicarbonate anions and possibly carbonate anions. Carbon dioxide gas-releasing compositions can be used in greenhouses by applying it to the soil surface to enrich the air surrounding plants. The carbon-dioxide-releasing compositions can also be used in modified atmosphere packaging by placing the composition within a package, exposing the composition to electromagnetic energy to generate carbon dioxide, and sealing the package to create a carbon dioxide atmosphere within the package. The package can then be used to control respiration of produce, cut flowers or other plants during storage and transportation, or to retard, prevent, inhibit or control biochemical decomposition of foods.

A nitrogen oxide such as nitrogen dioxide or nitric oxide is generated and released from a composition if it contains a source of nitrite anions. Suitable sources of nitrite anions include alkali metal nitrites such as sodium nitrite or potassium nitrite, alkaline-earth metal nitrites such as calcium nitrite, or nitrite salts of a transition metal ion, a protonated primary, secondary or tertiary amine, or a quaternary amine. Nitrogen dioxide or nitric oxide gas-releasing powders can be used to improve biocompatibility of biomaterials and for modified atmosphere packaging.

Ozone gas is generated and released if the composition contains a sources of peroxide anions. Suitable ozone sources that can be incorporated into the composition include alkali metal peroxides such as sodium peroxide or potassium peroxide, alkaline-earth metal chlorites such as calcium peroxide, or peroxide salts of a transition metal ion, a protonated primary, secondary or tertiary amine, or a quaternary amine.

Ozone-releasing compositions can be used to deodorize, enhance freshness, retard, prevent, inhibit, or control chemotaxis, retard, prevent, inhibit or control biochemical decomposition, or to kill, retard, control or prevent the growth of bacteria, molds, fungi, algae, protozoa, and viruses.

In some instances, compositions contain two or more different anions to release two or more different gases at different rates. The gases are released for different purposes, or so that one gas will enhance the effect of the other gas. For example, a composition containing bisulfite and chlorite anions may release sulfur dioxide for food preservation and chlorine dioxide for deodorization, freshness enhancement, control of chemotaxis, or control of microorganisms.

Any electromagnetic energy source capable of activating an energy-activated catalyst of the invention can be used to generate a gas from the composition. In other words, any electromagnetic energy source that provides a photon having energy in excess of the band gap of the energy-activated catalyst is suitable. Preferred electromagnetic energy sources include light, such as sunlight, fluorescent light, and ultraviolet light, for photo-activation of the composition. Ultraviolet light and visible light other than incandescent light, such as blue light, are preferred sources of electromagnetic energy. Additives such as UV blockers can also be included in the compostion if it is desirable to limit the wavelength range transmitted to the energy-activated catalyst. Photosensitizers can be added to shift the absorption wavelength of the composition, particularly to shift an ultraviolet absorption wavelength to a visible absorption wavelength to improve activation by room lighting.

UV absorbers can be added to the composition to slow the gas generation and control release rate.

Any semiconductor activated by electromagnetic energy, or a particle or other material incorporating such a semiconductor, can be used as the energy-activated catalyst of the composition. Such semiconductors are generally metallic, ceramic, inorganic, or polymeric materials prepared by various processes known in the art, such as sintering. The semiconductors,can also be surface treated or encapsulated with materials such as silica or alumina to improve durability, dispersibility or other characteristics of the semiconductor. Catalysts for use in the invention are commercially available in a wide range of particles sizes from nanoparticles to granules. Representative energy-activated catalysts include metal oxides such as anatase, rutile or amorphous titanium dioxide (TiO₂), zinc oxide (ZnO), tungsten trioxide (WO₃), ruthenium dioxide (RuO₂), iridium dioxide (IrO₂), tin dioxide (SnO₂), strontium titanate (SrTiO₃), barium titanate (BaTiO₃), tantalum oxide (Ta₂O₅), calcium titanate (CaTiO₃), iron (III) oxide (Fe₂O₃), molybdenum trioxide (MoO₃), niobium pentoxide (NbO₅), indium trioxide (In₂O₃), cadmium oxide (CdO), hafnium oxide (HfO₂), zirconium oxide (ZrO₂), manganese dioxide (MnO₂), copper oxide (Cu₂O), vanadium pentoxide (V₂O), chromium trioxide (CrO₃), yttrium trioxide (YO₃), silver oxide (AgO₂), or TiₓZr₍₁₋ₓ₎O₂ wherein x is between 0 and 1; metal sulfides such as cadmium sulfide (CdS), zinc sulfide (ZnS), indium sulfide (In₂S₃), copper sulfide (Cu₂S), tungsten disulfide (WS₂), bismuth trisulfide (BiS₃), or zinc cadmium disulfide (ZnCdS₂), metal chalogenites such as zinc selenide (ZnSe), cadmium selenide (CdSe), indium selenide (In₂Se₃), tungsten selenide (WSe₃), or cadmium telluride (CdTe); metal phosphides such as indium phosphide (InP); metal arsenides such as gallium arsenide (GaAs); nonmetallic semiconductors such as silicon (Si), silicon carbide (SiC), diamond (C), germanium (Ge), germanium dioxide (GeO₂) and germanium telluride (GeTe); photoactive homopolyanions such as W₁₀O₃₂⁻⁴; photoactive heteropolyions such as XM₁₂O₄₀⁻ⁿ or X₂M₁₈O₆₂⁻⁷ wherein X is Bi, Si, Ge, P or As, M is Mo or W, and n is an integer from 1 to 12; and polymeric semiconductors such as polyacetylene. Transition metal oxides such as titanium dioxide and zinc oxide are preferred because they are chemically stable, non-toxic, inexpensive, exhibit high photocatalytic activity, and are available as nanoparticles useful in preparing transparent formed or extruded plastic products.

The rate of gas release from any composition of the invention, activation of the composition to initiate gas release, and the release rate profile can be altered in various ways, such as by changing the concentration of energy-activated catalyst or anion source in the composition, adding a base, surfactant, diluent, or light filtering additive to the composition, adding materials such as silicates to complex active surface sites, introducing charge, lattice or surface defects in the catalyst (e.g., Ti³⁺ impurities in titanium based catalysts), changing the method of processing the composition, modulating light wavelength the intensity, or changing the order of addition of ingredients in preparing the composition.

Up to about 99% of any conventional powder, film, coating or catalytic additive based upon the total weight of the composition can be included in the compostions of the invention. Such additives include colorants and dyes, fragrances, fillers, lubricants, stabilizers, accelerators, retarders, enhancers, blending facilitators, controlled release agents, antioxidants, UV blockers, mold release agents, plasticizers, biocides, flow agents, anti-caking agents, processing aids, and light filtering agents.

Preferable additives for controlling gas release include bases, surfactants and light filtering agents. A base is believed to stabilize anions during processing and participate in the electron transfer by producing hydroxyl radicals which aid in oxidation of the anions. The amount of the base within the composition can be adjusted to alter the time period of gas release and enhance the thermal stability of the composition.

For example, the concentration of the base can be increased if a longer delay of gas release is desired. Up to about 50 wt. % of a base based upon the total weight of the composition is preferably included in a composition of the invention.

Suitable bases include, but are not limited to, an alkali metal hydroxide such as lithium, sodium or potassium hydroxide, an alkaline-earth metal hydroxide such as calcium or magnesium hydroxide, a hydroxide salt of a transition metal ion, a protonated primary, secondary or tertiary amine, or a quaternary amine such as ammonium hydroxide.

A surfactant is believed to create a mobile ion layer on a surface of the composition to speed charge transfer between the anion and valence band holes. Any surfactant that alters the gas release rate can be added to the composition.

Representative surfactants include Triton X-301 (an ethoxylated alkylphenol sulfate salt manufactured by Union Carbide) and Triton X-100 (an alkyl aryl ethoxylate manufactured by Union Carbide).

Light filtering additives can control the transfer of incident light into the composition to decrease the gas release rate. Suitable light filtering additives include silicates and clays. Any silicate that is soluble in water or a water solution of a water miscible organic material can be used in preparing the compositions of the invention. Suitable silicates include sodium silicate, sodium metasilicate, sodium sesquisilicate, sodium orthosilicate, borosilicates and aluminosilicates. Commercially available forms of such silicates suitable for use generally include sodium and potassium cations. The ratio of silicon measured as SiO₂ to alkali metal cation measured as M₂O in the silicate particles, wherein M is selected from the group consisting of sodium and potassium, is between about 2.0 and about 4.0, preferably between about 2.3 and about 3.5, most preferably between about 2.5 and about 3.2. By way of an example, without limitation thereto, when the energy-activated catalyst is titanium dioxide, the light filtering additive can be silica. Silica treatment can be in amount of about 3 wt. % based on the entire weight of the treated titanium dioxide.

Applications for the compositions are numerous. The compositions can be used in most any environment where exposure to electromagnetic energy can occur. The compositions which are in the form of powders can be formed into solids by molding or sintering. The powders can also be impregnated, melt processed, sintered, blended with other powders or otherwise incorporated into a variety of materials to provide films, fibers, coatings, tablets, resins, polymers, plastics, tubing, membranes, engineered materials, paints and adhesives for a wide range of end use applications. The powders are particularly useful in preparing any injection-molded products, compression-molded products, thermal-formed products, or extrusion-formed products such as cast or blown films. The thermal stability of the powders allows for their use in injection molding processes.

The powders of the present invention are preferably incorporated into injection-molded, compression-molded, thermal-formed, or extrusion-formed plastic products by compounding and pelletizing the powder via conventional means and admixing the pellets with a material before the conventional forming or molding process. Suitable materials for forming these products include any polymer, multicomponent polymer such as a copolymer, a terpolymer or an oligomer, and polymer alloys or blends thereof or any wax. Representative polymers include polyolefins such as polyethylene and polypropylene, polyethylene terephthalate, polyvinyl chloride, polyurethanes, metallocene polymers, polyesters, polyacrylic esters, acrylic, polystyrene, polycarbonates, polyamides, polyester amides, ethylene-vinyl acetate copolymers, ethylene-methacrylate copolymers, and polyacetals. Suitable waxes include microcrystalline wax, paraffin wax, and synthetic wax such as chlorinated wax, polyethylene wax, polyethylene glycols and polypropylene glycols.

The formed or molded products preferably include between about 0.1 and about 70 wt. % of the powder of the invention and between about 30 and about 99.9 wt. % of the material, and more preferably, between about 1 and about 50 wt. % of the powder of the invention and between about 50 and about 99 wt. % of the material, and most preferably, between about 2 and about 50 wt. % of the powder of the invention and between about 50 and about 98 wt. % of the material.

The formed or molded products can be made by any conventional polymer processing method. For example, a powder or powder pellets of the invention and the material can be mixed together in a mixer, such as a Henschel mixer, and fed to an extruder or molding apparatus operated at a temperature not exceeding about 200° C. to form a melt. The melt can be cast-extruded as a film, formed into pellets using dry air cooling on a vibrating conveyer, or formed into a desired shape by conventional injections-molding, thermal-forming, or compression-molding methods.

The melt can be applied on a surface as film by using well known hot melt, dip coat, spray coat, curtain coat, dry wax, wet wax, and lamination processes.

When the composition of the invention is in nanoparticle form (e.g. 50 Angstrom diameter), a transparent film may be formed.

Conventional film forming additives can be added to the materials as needed. Such additives include crosslinking agents, stabilizers, flame retardants, emulsifiers, compatibilizers, lubricants, antioxidants, colorants, and dyes.

A multilayered composite can be formed to generate a gas within an enclosure formed of the composite. Such a composite includes a gas generating layer and a barrier layer. The gas generating layer includes an energy-activated catalyst capable of being activated by electromagnetic energy and anions capable of being oxidized or reacted to generate a gas. The barrier layer is adjacent to a surface of the gas generating layer. The barrier layer is transparent to electromagnetic energy such that it transmits the energy to the gas generating layer. However the barrier layer is impermeable or only semipermeable to the gases generated and released by the gas generating layer. The gas generating layer, when exposed to electromagnetic energy is capable of generating and releasing the gas after activation of the catalyst and oxidation or reaction of the anions.

Gas-releasing powders, suspensions, or other compositions of the invention can be used to retard, kill, prevent or control microbilogical contamination on a surface of a material, within the material or in the atmosphere surrounding the material by placing the material adjacent to a composition of the invention, and exposing the composition to electromagnetic energy to release a biocidal gas from the composition into the atmosphere surrounding the material.

Gas-releasing compositions can be used to retard, prevent, inhibit or control biochemical decomposition on a surface of a material or within the material by placing the material adjacent to a composition of the invention, and exposing the composition to electromagnetic energy to generate and release a biochemical decomposition-inhibiting gas from the composition into the atmosphere surrounding the material.

The material is preferably produce such as fruits or vegetables, or other food. The food is preferably stored or transported in modified atmosphere packaging to extend the shelf life of the food by retarding, preventing, inhibiting or controlling biochemical decomposition or microbiological contamination.

The gas-releasing compositions can also be used to control respiration of a material by placing the material adjacent to a composition of the invention, and exposing the composition to electromagnetic energy to generate and release a respiration-controlling gas from the composition into the atmosphere surrounding the material. The material is preferably fruits, vegetables, meats, meat products, seafood, seafood products, or other foods, or flowers or other plants.

Control of respiration of foods and flowers is generally accomplished by storing and transporting the food or flowers in modified atmosphere packaging or selective gas permeable packaging.

The gas-releasing compositions can also be used to deodorize a surface of a material or the atmosphere surrounding the material or enhance freshness of the material by placing the material adjacent to the composition, and exposing the composition to electromagnetic energy to generate and release a deodorizing gas from the composition into the atmosphere surrounding the material.

The gas-releasing compositions can also be used to retard, prevent, inhibit, or control chemotactic attraction of an organism to a material by placing the material adjacent to the composition, and exposing the composition to electromagnetic energy to generate and release an odor-masking or odor-neutralizing gas from the composition into the atmosphere surrounding the material.

The gas-releasing compositions can also be used to retard, prevent or control biological contamination of an atmosphere by exposing the composition to electromagnetic energy to generate and release a decontaminating gas from the composition into the atmosphere surrounding the composition.

The compositions can also be used to retard, prevent or control biological contamination of a material by placing the material adjacent to the composition, and exposing the composition to electromagnetic energy to generate and release a decontaminating gas from the composition into the atmosphere surrounding the material. The decontaminating gas, for example, is used following biological warfare to deactivate the biological contaminant (e.g., anthrax) or for other military decontamination.

The composition of the invention for use in the above methods is preferably a solid or a liquid such as a solids-containing suspension.

In the above methods, the surface of the material or the entire material can be impregnated with a powder of the invention or coated with the composition, the composition can be admixed with the material, the composition can be enclosed within a gas-permeable container, or the material and the composition can be enclosed within a container. When the composition is enclosed within a container, the container can be hermetically sealed, or partially sealed such that some gas leaks from the container.

The chlorine dioxide-releasing powder, for example, can be impregnated into containers used to store food products, soap, laundry detergent, documents, clothing, paint, seeds, medical instruments, devices and supplies such as catheters and sutures, personal care products, medical or biological waste, athletic shoes, ostomy bags, footwear, and refuse.

Such a powder can also be impregnated into covers for medical, hospital, home or commercial equipment or covers used in storage. A packet, sachet bag, “tea bag” or other gas-permeable container of the powder can be included in a storage container to provide a chlorine dioxide microatmosphere upon activation. The chlorine dioxide-releasing powder can also be impregnated into a paper or polymeric material (e.g., a shower mat, shoe inserts or insoles, bandage material, a meat cutting board, a food wrapper, a food packaging tray, a seed packet, or an air filter); incorporated into a wax or polymeric coating applied to paperboard containers or other surfaces; incorporated into films such as packaging films or covers for storage or medical, hospital, home or commercial equipments; formed into porous parts to sterilize water; admixed with a material to create a microatmosphere of chlorine dioxide about the material (e.g., soil); or admixed with other powders to kill microorganisms, enhance freshness or deodorize (e.g., foot powders, bath powders, powders for treating soft surfaces such as carpet powders, desiccants for moisture removal).

The powders can also be admixed with binders or other conventional tabletting materials to form tablets that can be dissolved in water at the point of use to generate and release chlorine dioxide for flower preservation, surface disinfection, sterilization of medical devices, or use as a mouthwash. The suspensions of the invention can also be packaged as ready-to-use products for such end uses.

Suspensions of the powder of the invention can be used for the purposes identified above for powders. For example, a suspension can be applied to finger nails or toe nails to prevent, reduce, inhibit or control the growth of fungus or whiten the nail, or can be included in nail polish formulations for these purposes. Such suspensions preferably include from about 0.1 to about 50 wt. % of the powder of the invention, from about 20 to about 50 wt. % polymer such as poly(methylmethacrylate) or polyvinyl alcohol, and up to about 79.9 wt. % solvent such as water for water-soluble formulations, or methanol or methylethylketone for non-water-soluble formulations. Suspensions of the invention can also be used in dental applications for localized disinfection in an oral cavity, for example, by applying the composition to a tooth surface before an ultraviolet-cured adhesive is exposed to ultraviolet light to cure the adhesive and form a tooth filling. The ultraviolet light activates the composition to generate and release a disinfecting gas. Compositions of the invention can also be incorporated into a paste for temporary, permanent, or semi-permanent oral care uses.

In addition to deodorization to neutralize malodors, the compositions can be used to retard, prevent, inhibit, or control chemotaxis (i.e., the attraction of a living organism to a chemical substance). For example, odors from food can attract insects to the food. When the food is adjacent to a composition of the invention that releases an odor-masking gas, the odor released from food is indistinct or imperceptible to the insects. The compositions of the invention can also be used to release an odor-neutralizing gas so that the odor released from food is reduced or eliminated and insects are not attracted to the food.

The powders are also especially suitable for use in animal feeds. During preparation and handling, animal feeds for monogastric animals, such as chickens, swine, cats, dogs, rabbits, rats, mice and the like, are often contaminated with bacteria which infect the animal. If the powders of the present invention are formed from edible components, including edible protein coatings, the powders can be incorporated into the animal feed during any stage of production, before transportation or storage of the feed, or before use of the feed so that the chlorine dioxide will reduce or eliminate the bacterial within the feed. The controlled sustained release powders also reduce the bacterial load in the intestines of such monogastric animals.

The compositions of the invention effectively release a gas at temperatures generally encountered in the above uses, including refrigeration temperatures. The chlorine dioxide-releasing compositions, for example, can be used in packaging medical supplies, food or other materials that require refrigeration to sterilize or deodorize the materials. The multilayered films including a barrier layer can also be used to form packaging such as used for medical supplies or food.

The barrier layer retains the generated gas within the packaging, for example, to enhance shelf life and prevent mold growth in foods or enhance sterilization of medical supplies.

Preferably, the energy-activated catalyst is titanium dioxide which is commercially available from E.I. du Pont de Nemours and Company (including but not limited to grades R-100, R-101, R-706 and R-700) and Degussa P25. Another useful energy-activated catalysts is zinc oxide. The energy-activated catalysts can be rutile, anatase or amorphous TiO₂. Titanium dioxide pigments and nano-sized titanium dioxide are preferred. Especially preferred are rutile and anatase titanium dioxide having an average particle size diameter of less than about 5,000 Å and typically having a particle size of about 1,000 to about 5,000 Å. For nano-sized titanium dioxide, the size range can be from about 10 to about 175 nanometers in average particle diameter, particularly about 30 to about 150 nanometers, and most particularly about 50 to about 125 nanometers. Typically particle size diameter is of agglomerates and is determined by any well-known technique such as SAXS, light-scattering, and electron microscopy. The titanium dioxide also may contain ingredients added thereto to improve the durability characteristics or other properties of the pigment. Thus, the titanium dioxide may contain hydrous oxides such as silica, alumina, tin oxide, lead oxide, chromium oxides, and the like.

The titanium dioxide can be surface treated with various organic compounds including but not limited to polyols and substituted polyols, silicones, siloxanes, alkanolamines, such as triethanolamine and silanes. Suitable silanes have the formula:
RₓSi(R′)₄₋ₓ
wherein
R is a nonhydrolyzable aliphatic, cycloaliphatic or aromatic group having at least 1 to about 20 carbon atoms;
R′ is a hydrolyzable group such as an alkoxy, halogen, acetoxy or hydroxy or mixtures thereof; and
x=1 to 3.
For example, silanes useful in carrying out the invention include hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane and octadecyltriethoxysilane. Additional examples of silanes include, R=8-18 carbon atoms; R′=chloro, methoxy, hydroxy or mixtures thereof; and x=1 to 3. Preferred silanes are R=8-18 carbon atoms; R′=ethoxy; and x=1 to 3. Mixtures of silanes are contemplated equivalents. Weight content of the silane, based on total silanized pigmentary TiO₂ is typically about 0.3 to about 2.0 wt. %, preferably about 0.7 to about 1.0 wt. %. In excess of 2.0 wt. % may be used but no particular advantage is observed.

The titanium dioxide of this invention can be silanized as described in U.S. Pat. Nos. 5,889,090; 5,607,994; 5,631,310; and 5,959,004, which are incorporated herein by reference in their entireties. Silanization can occur either before or after treating with a source of anions capable of being oxidized or reacted to generate a gas. As described in the foregoing patents, the titanium dioxide may also contain ingredients added thereto to further improve dispersibility characteristics of other properties such as durability. Thus, by way of example, but not limited thereto, the titanium dioxide may contain additives and/or inorganic oxides, such as aluminum, silicon or tin as well as triethanolamine, trimethylolpropane, phosphates, phosphites, etc.

In one embodiment, the invention herein can be construed as excluding any element or process step that does not materially affect the basic and novel characteristics of the composition or process. Additionally, the invention can be construed as excluding any element or process step not specified herein.

### EXAMPLES

### Test Procedure Used in Examples

Ion Chromatography (“IC”)

Aqueous solutions are injected into an ion-exchange column and ions of interest are separated with the aid of an eluent containing an electrolyte (milli M levels of NaOH, NaHCO₃ or Na₂CO₃). The separation mechanism and retention time depend primarily on the affinity of the analyte ions for the charged sites on the stationary phase (resin beads) and the concentration of competing ions. The eluent with ions separated goes into a “suppressor”, which converts the competing ions from the eluent into a less conductive form (protonated—see below). The conductivity of the separated ions (with the competing ions removed) is recorded and peaks are generated based on conductivity. The peaks are compared against known standards for both time and area to determine the anion and its concentration.
Protonate eluent: NaOH+H⁺=H₂O+Na⁺
NaHCO₃+H⁺=H₂O+Na⁺+CO₂
This also converts most anions into a more conductive acid form for an increase in signal (conductivity).
Conditions for Analysis:

Columns: DIONEX AS17

Eluent: 0.1-50 milli M NaOH

Flow: 1.0 milli L/min

Sample Loop: 40 micro L

Suppression: Elec 100 micro A

Method: EG1_AS17_Long

The results from the IC are reported in micro g/milli L. The calculation below is used to convert the micro g/milli L to ppm: {[(IC Result ug/mL×dilution )−preparation blank]×[extraction volume]}/[weight of extracted sample)]=ppm in original sample.

In the following examples all parts are measured on a weight basis.

### Example 1

A solution of sodium chlorite (NaClO₂) was prepared by dissolving 30.0 parts technical grade (80% active) sodium chlorite in 70 parts high purity water (deionized and polished).

The solution was fed to an injector apparatus such as that shown in FIGS. 1 and 2 in order to treat titanium dioxide pigment particles R-101 sold by E. I. du Pont de Nemours and Company and Degussa P25. The titanium dioxide pigment was metered at a feed rate of 300 to 800 g/minute while the sodium chlorite solution feed rate was 50-250 g/minute. The gas stream was nitrogen which was injected through the flow restrictor at a pressure of 60 psig and the temperature of the gas stream was 325° C. The mean residence time in the zone of turbulence was about 1-2 milli-seconds.

The weight % amounts of sodium chlorite and chlorite ion based on the total weight of the catalyst and salt are shown in Table 1.

The gas stream was nitrogen which was injected through the flow restrictor at a pressure of 60 psig and the temperature of the gas stream was 325° C. The mean residence time in the zone of turbulence was about 1-2 milli-seconds.

TABLE 1
Coating in Zone of Turbulence

| TiO₂ Grade | wt. % NaClO₂ | wt. % ClO₂⁻ |
|---|---|---|
| P25 | 7.43 | 1.72 |
| R-101 | 5.51 | 2.01 |
| R-101 | 5.51 | 1.84 |

### Example 2

A solution of sodium chlorite was prepared as described above. Dispersions of the titanium dioxide (R-101 and P25) in water were made at about 30-50 wt. % at pH 8-9 using 2-amino-2-methy-1-proparol to control pH. To this dispersion was added an amount of sodium chlorite solution and water to give about 18 wt. % titanium dioxide in water which was spray dried by atomization using nozzles at a temperature ranging from about 190 to about 220° C. The weight % amounts of sodium chlorite and chlorite ion based on the total weight of the catalyst and salt are shown in Table 2.

TABLE 2
Spray Dryer

| TiO₂ Grade | wt. % NaClO₂ | wt. % ClO₂⁻ |
|---|---|---|
| P25 | 5 | <0.02 |
| P25 | 10 | <0.02 |
| R-101 | 5 | 1.22 |
| R-101 | 10 | 4.46 |

Comparing the data reported in Tables 1 and 2, it is apparent that the process of this invention for treating the titanium dioxide with the chlorite provides a composition with a higher concentration of chlorite ion as compared to spray drying. This is unexpected since spray drying uses lower temperatures and milder conditions which would be considered more favorable to the sodium chlorite.

Sample using P25 is thought to demonstrate a lower wt. % chlorite because of its high activity. The samples made with P25 might liberate chlorine dioxide more readily.

### Example 3

The energy activated catalysts of Table 3 were each treated with sodium chlorite following the procedure of Example 1 to produce treated samples.

The treated samples were exposed to ultra violet radiation using a 10 watt UV bulb at six 30-second intervals. The amount of ClO₂ released was detected using an Interscan LD Series Model 33 ClO₂ detector. The results are reported in Table 3.

TABLE 3
ClO₂ ppm

| Sample | 30 sec. | 60 sec. | 90 sec. | 120 sec. | 150 sec. | 180 sec. |
|---|---|---|---|---|---|---|
| TiO₂ R-101 | 2.9 | 6.2 | 8.5 | 10.0 | 10.8 | 11.5 |
| grade | | | | | | |
| Zinc Oxide | 1.0 | 2.1 | 3.0 | 3.5 | 4.0 | 4.3 |
| Silicate Clay | 0.0 | 0.3 | 0.4 | 0.6 | 0.6 | 0.6 |

It is believed that silicate clay of this example which is considered to lack photoactivity produced a minor amount of ClO₂ from direct photogeneration from the NaClO₂.

### Example 4

In this example titanium dioxide photopassivated with silicon dioxide was treated with sodium chlorite following the procedure of Example 1. The photopassivated titanium dioxide contained 3 wt. % silica and 2 wt. % alumina, based on the entire weight of the photopassivated TiO₂ R-706 sold by E. I. du Pont de Nemours and Company. The treated sample was exposed to UV light and the amount of ClO₂ released was determined by the procedures described in Example 3. The results are reported in Table 4.

TABLE 4
ClO₂ ppm

| | 30 | | | | | |
|---|---|---|---|---|---|---|
| Sample | sec. | 60 sec. | 90 sec. | 120 sec. | 150 sec. | 180 sec. |
| Photopassivated | 1.2 | 3.3 | 4.7 | 5.7 | 6.4 | 6.9 |
| TiO₂ | | | | | | |

As shown in Table 4, photopassivated TiO₂ showed reduced ClO₂ generation as compared to the titanium dioxide samples of Table 1 which were not photopassivated.

### Example 5

Powdered NaClO₂ and powdered titanium dioxide (R-101) were blended using a mortar and pestle to give a mixture containing about 8.8 wt. % NaClO₂ (about 5.3 wt. % ClO₂⁻ anion) and showed no ClO₂ release on exposure to UV light for 3 minutes.

The description of illustrative and preferred embodiments of the present invention is not intended to limit the scope of the invention. Various modifications, alternative constructions and equivalents may be employed without departing from the true spirit and scope of the appended claims.

What is claimed is:

1. A composition for generating at least one gas comprising an energy-activated catalyst capable of being activated by electromagnetic energy, heat and/or moisture and anions capable of being oxidized or reacted to generate at least one gas, the composition, when exposed to the electromagnetic energy, heat and/or moisture being capable of generating and releasing the gas after activation of the catalyst and oxidation or reaction of the anions comprising making the composition by:
(a) metering a liquid composition comprising a source of the anions into a flow restrictor;
(b) injecting a gas stream through the flow restrictor, concurrently with step (a) to create a zone of turbulence at the outlet of the flow restrictor, thereby atomizing the liquid composition;
(c) heating the gas stream prior to injecting the gas stream through the flow restrictor; and
(d) adding the energy-activated catalyst to the zone of turbulence concurrently with steps (a) and (b) to contact the energy-activated catalyst with the atomized liquid composition wherein the contacting at the zone of turbulence provides a composition for generating at least one gas comprising an energy-activated catalyst capable of being activated by electromagnetic energy, heat and/or moisture and anions capable of being oxidized or reacted to generate at least one gas.

2. The composition of claim 1 wherein the energy-activated catalyst is a metal oxide.

3. The composition of claim 1 wherein the energy-activated catalyst is rutile, anatase or amorphous titanium dioxide.

4. The composition of claim 1 wherein the anions are chlorite, bisulfite, sulfite, hydrosulfide, sulfide, hypochlorite, cyanide, bicarbonate, carbonate and nitrite.

5. The composition of claim 1 wherein the gas is chlorine dioxide, sulfur dioxide, hydrogen sulfide, chlorine, dichlorine monoxide, hydrocyanic acid, carbon dioxide, nitrogen dioxide, nitric oxide and ozone.

6. The composition of claim 1 wherein the source of anions is an alkali methal chlorite, an alkaline-earth metal chlorite or a chlorite salt of a transition metal ion.

7. The composition of claim 1 wherein the source of anions is sodium chlorite.

8. The composition of claim 1 further comprising a polymeric article having the composition embedded therein or applied to a surface thereof whereby the polymeric article generates and releases gas upon activation of the composition by electromagnetic energy and/or moisture.

9. The composition of claim 9 wherein the polymeric article is a film.

10. The composition of claim 9 wherein the polymeric article is a body covering article.

11. The composition of claim 1 in which the energy-activated catalyst is treated with a light filtering additive.

12. The composition of claim 11 in which the energy activated catalyst is titanium dioxide and the light filtering additive is silicon dioxide.

13. A process for making a composition for generating at least one gas comprising an energy-activated catalyst and anions capable of being oxidized or reacted to generate the at least one gas comprising:
(a) metering a liquid composition comprising a source of the anions into a flow restrictor;
(b) injecting a gas stream through the flow restrictor, concurrently with step (a) to create a zone of turbulence at the outlet of the flow restrictor, thereby atomizing the liquid composition;
(c) heating the gas stream prior to injecting the gas stream through the flow restrictor; and
(d) adding the energy-activated catalyst to the zone of turbulence concurrently with steps (a) and (b) to contact the energy-activated catalyst with the atomized liquid composition wherein the contacting at the zone of turbulence treats the energy-activated catalyst with the source of the anions to form a composition which when exposed to electromagnetic energy, heat and/or moisture is capable of generating and releasing the gas after activation of the catalyst and oxidation or reaction of the anions.

14. The process of claim 11 wherein the energy-activated catalyst is a metal oxide.

15. The process of claim 11 wherein the energy-activated catalyst is rutile, anatase or amorphous titanium dioxide.

16. The process of claim 11 wherein the anions are chlorite, bisulfite, sulfite, hydrosulfide, sulfide, hypochlorite, cyanide, bicarbonate, carbonate and nitrite.

17. The process of claim 11 wherein the gas is chlorine dioxide, sulfur dioxide, hydrogen sulfide, chlorine, dichlorine monoxide, hydrocyanic acid, carbon dioxide, nitrogen dioxide, nitric oxide and ozone.

18. The process of claim 11 wherein the source of anions is an alkali methal chlorite, an alkaline-earth metal chlorite or a chlorite salt of a transition metal ion.

19. The process of claim 11 wherein the source of anions is sodium chlorite.

20. The process of claim 11 further comprising combining the composition with a polymeric article that generates and releases gas upon activation by electromagnetic energy and/or moisture.

21. The process of claim 13 in which the energy-activated catalyst is treated with a light filtering additive.

22. The process of claim 21 in which the energy activated catalyst is titanium dioxide and the light filtering additive is silicon dioxide.
